(19) United States
(12) Patent Application Publication
(10) Pub. No.: US 2025/0102209 A1
(43) Pub. Date: Mar. 27, 2025

(54) PRESSURE RELIEF ARRANGEMENT IN REFRIGERANT CIRCUITS

(71) Applicant: Hanon Systems, Daejeon (KR)

(72) Inventor: Peter Heyl, Köln (DE)

(21) Appl. No.: 18/944,223

(22) Filed: Nov. 12, 2024

Related U.S. Application Data
(62) Division of application No. 17/755,844, filed on May 10, 2022.

(30) Foreign Application Priority Data
Dec. 10, 2019 (DE) 10 2019 133 779.8
Nov. 17, 2020 (DE) 10 2020 130 285.1

(51) Int. Cl. F25B 49/02; B60H 1/32; F25B 41/20; F28F 27/00

(52) U.S. Cl. CPC F25B 49/022; B60H 1/3225; F25B 41/20; F28F 27/00; F25B 2400/12; F25B 2600/0262; F25B 2600/0271; F25B 2700/1931; F25B 2700/21152; F28F 2265/12

(57) ABSTRACT

A pressure relief arrangement in refrigerant circuits with one high-pressure side and one low-pressure side, which is characterized in that the high-pressure side is fluidically connected with the low-pressure side of the refrigerant circuit via an overpressure relief device, wherein the overpressure relief device causes pressure reduction of the overpressure in the case of overpressure on the high-pressure side and fluid flows from the high-pressure side to the low-pressure side of the refrigerant circuit.

### CROSS REFERENCE TO RELATED APPLICATIONS

This patent application is a divisional patent application of U.S. patent application Ser. No. 17/755,844 filed May 10, 2022 which is a U.S. national phase patent application of PCT/KR2020/017698 filed Dec. 4, 2020 which claims the benefit of and priority to German Pat. Appl. No. 10 2020 130 285.1 filed on Nov. 17, 2020 and German Pat. Appl. No. 10 2019 133 779.8 filed on Dec. 10, 2019, the entire contents of each of which are incorporated herein by reference.

### TECHNICAL FIELD

The invention relates to a pressure relief arrangement in refrigerant circuits, in particular in mobile refrigerant systems and heat pumps.

### BACKGROUND ART

The term ‘pressure relief arrangement’ refers to safety-related elements of pressurized systems which are used e.g. in refrigerant circuits in mobile applications of motor vehicle air conditioning to be able to minimize safety-relevant overpressure and resulting risks for both the passengers and the vehicle itself.

The field of application of the invention relates, in particular to refrigerant circuits with flammable refrigerants, such as R290 and R1234yf.

In prior art, flammable refrigerants, such as R290, are used in most cases in stationary systems and not in motor vehicle air conditioning, wherein there are safety concerns and reservations, in particular with reference to the filling quantity of flammable refrigerant which can be filled into motor vehicle air-conditioning systems. At best, indirect refrigerant systems are designed which require an additional refrigerant circuit which is disadvantageous in mobile applications due to the additional expenditure of space, weight and cost.

The safety issues in respect of motor vehicle air-conditioning systems already plays an important role in prior art, in particular in case of damage.

According to U.S. Pat. No. 5,918,475, it is suggested, for example, in case of damage on motor vehicle air-conditioning systems to close the air outlet of the air-conditioning system towards the passenger compartment to be able to prevent or reduce the flowing of refrigerant into the passenger compartment. According to this strategy, it is not possible, however, to prevent the loss of refrigerant from the system, but instead only the consequence of the damage—the flow of refrigerant into the passenger compartment—is mitigated.

According to U.S. Pat. No. 5,983,657, a combination of an electromagnetic valve and a non-return valve is suggested for use in a motor vehicle air-conditioning system to be able to prevent the refrigerant from flowing out of the evaporator when the compressor is not operating, wherein the expansion valve is used as the electromagnetic valve.

It is disadvantageous in the described prior art that, in particular when using the expansion valve as a shut-off valve, the expansion valve is limited in its actual function due to the required sealing function. In addition, it is to be taken into account that an expansion element extended by such an additional function is more expensive due to the more complex design.

A further known problem when using flammable refrigerants in refrigerant circuits is that such systems do not use an accumulator to keep the filling quantity of flammable refrigerant and the internal volume of the system as minimal as possible. According to the state of the art, without accumulator, a superheat controller is used which has significant influence on the efficiency of the refrigerant circuit. If a very low superheat is applied at the evaporator outlet, the superheat control becomes very unstable, wherein the superheat is controlled by way of a thermostatic or electronic expansion valve via the state of the refrigerant upstream of the evaporator outlet.

In addition to the problems described above, a special aspect is to be taken into account with flammable refrigerants that, in case of damage, inflammable mixtures arise which produce by-products when combusted which can cause serious damage. Furthermore, the costs of some refrigerants are relatively high. Thus, the widespread strategy of discharging the refrigerant into the environment in case of overpressure which results in formation of ignitable mixtures and thus involves the risk of explosion, is disadvantageous in terms of safety, ecology and costs.

### SUMMARY

The task of the invention is thus to provide a pressure relief arrangement in refrigerant circuits to realize safe reaction of the technical system to critical overpressure of the refrigerant on the high-pressure side.

The task of the invention is solved by way of a pressure relief arrangement as shown and described herein.

The task of the invention is solved, in particular by way of a pressure relief arrangement that is used in refrigerant circuits with one high-pressure side and one low-pressure side. The invention is characterized in that the high-pressure side is fluidically connected with the low-pressure side of the refrigerant circuit via an overpressure relief device. In case of overpressure on the high-pressure side, the overpressure relief device results in pressure reduction of the overpressure and fluid flows from the high-pressure side to the low-pressure side of the refrigerant circuit. The term ‘overpressure relief device’ within the meaning of the invention thus refers to a safety device that reacts on a certain specified overpressure that is either preset by default or can be specified as a control parameter and mechanically releases a flow path through which fluid flows with overpressure from the high-pressure side of the refrigerant circuit to the low-pressure side of the refrigerant circuit, resulting in pressure reduction on the high-pressure side.

According to the concept of the invention, the pressurized refrigerant is not released or discharged into the environment because ignitable, explosive mixtures of refrigerant and ambient air and the oxygen contained therein could be formed. Instead, the concept of the invention is to discharge the refrigerant in the closed system of the refrigerant circuit in appropriate hazardous situations or in case of overload conditions from the high-pressure area into the low-pressure area. The refrigerant is thus not lost for the system, but is relocated within the system to an area of the refrigerant circuit which can still accommodate refrigerant.

The overpressure relief device is produced preferably as a component of the refrigerant circuit which fluidically connects two different components of the refrigerant circuit to one another, wherein one component of the refrigerant circuit is under high pressure on the high-pressure side and the other one is correspondingly under low pressure on the low-pressure side of the refrigerant circuit. The overpressure relief device connects the two components to one another fluidically.

An alternative and especially preferred embodiment of the invention is the overpressure relief device arranged in or integrated into a component of the refrigerant circuit, which results in an especially compact and easy-to-assemble embodiment of the invention, wherein fluid-carrying areas inside the component of the refrigerant circuit which carry fluid under high pressure are produced as the high-pressure side, and areas that carry fluid under low pressure as the low-pressure side, wherein the two are fluidically connected with each other via the overpressure relief device. Various components of refrigerant circuits are known which possess both areas with high pressure and with low pressure and which can be produced accordingly as described with an overpressure relief device as an integrated part of the component.

The overpressure relief device is arranged preferably in a pressure relief channel between the high-pressure side and the low-pressure side of a compressor. The compressor-a refrigerant compressor-possesses a housing enclosing it, and the pressure relief channel can be produced inside the housing of the compressor or, alternatively, arranged inside the housing of the compressor as a separate fluid line. As already mentioned, the overpressure relief device is arranged inside the pressure relief channel or on the end of the channel, depending on the design conditions.

The overpressure relief device is preferably integrated into the housing of the compressor from the inside, without a passage existing to the outside. Thus, it is possible to realize pressure relief by way of an additional component inside the housing, without creating an additional sealing problem due to this additional component of the overpressure relief device. The overpressure relief device itself does not exhibit any connection through the housing to the outside and is hermetically integrated into the compressor.

To this end, the overpressure relief device is preferably screwed into the housing from the inside.

Alternatively, the overpressure relief device is integrated into the housing of the compressor from the outside, and according to an advantageous embodiment of this alternative, the overpressure relief device is screwed into the housing from the outside.

To be able to realize sealing of the additional housing opening which may be present when arranging the overpressure relief device from the outside, preferably a metallic gasket is intended to install which seals the overpressure relief device externally towards the environment. Furthermore, a second gasket is produced as an 0-ring to seal the overpressure relief device internally and separate the high-pressure area from the low-pressure area.

The overpressure relief device is produced preferably as a pressure relief valve or as a rupture disc.

An advantageous embodiment of the pressure relief valve is that it exhibits a valve body, wherein an overflow channel runs axially in the valve body.

An advantageous embodiment of the pressure relief arrangement is that the overpressure relief device is produced in two stages, wherein a pressure equalization between the high-pressure side and the low-pressure side is performed internally in a first stage and a pressure equalization towards the environment is performed externally in a second stage. The objective of this strategy is to leave the refrigerant in the circuit for safety, environmental and cost reasons as in the variant already described above. If the pressure, however, further increases, it is better to discharge the refrigerant into the environment.

A further embodiment of the pressure relief arrangement is that the overpressure relief device is integrated into a heat exchanger with adjacent heat transfer modules for high pressure as a condenser and for low pressure as an evaporator, wherein the overpressure relief device is arranged at a separation wall between high pressure and low pressure in such a way that a fluidic connection is established between high-pressure side and low-pressure side when triggering the pressure relief, and the fluid flows under high pressure into the low-pressure side.

In an especially preferred embodiment, the overpressure relief device is arranged in the manifold/collector of the heat exchanger.

According to the invention, the pressure relief arrangement is advantageous, in particular by avoiding escape of flammable refrigerants into the environment with reference to increase of the safety and mitigation of the risk of explosion or fire arising from flammable refrigerants. A further advantageous aspect is that the escaping refrigerants and refrigerant mixtures constitute an environmental load, and an ecologically advantageous solution is reached by prevention of flowing into the environment.

Thus, the refrigerant is retained in the system of the externally closed refrigerant circuit and can be used further. Furthermore, no additional costs incur for refilling and topping up the sometimes expensive refrigerants.

The problem of instability of the superheat control at the evaporator outlet is solved by a cost-saving control of the superheat on the high-pressure level by using the existing sensors, wherein a superheat control is performed in the range of 10 . . . 15 K and in particular even in the range of 15 . . . 20 K.

Thus, the superheat upstream of the compressor inlet is controlled by way of the superheat at the compressor outlet. The concept of the invention is, in particular that the superheat upstream of the compressor inlet and thus also the temperature difference between refrigerant and the heat transfer medium or the air should be as low as possible, wherein the control is very unstable, and the objective is to achieve very low superheat to keep the thermodynamic losses as low as possible.

The pressure sensor and a separate temperature transducer or a combined pressure-temperature sensor at the compressor outlet is used for controlling. The advantage of the specified control strategy is that the existing pressure and temperature sensor calculates a safe superheat at the compressor outlet which corresponds to a low superheat at the evaporator outlet, wherein the control at the compressor outlet is much more stable since the superheat is significantly greater than on the low-pressure side; the control device for the compressor is additionally reinforced via the pressure and temperature sensor in that the compressor can be throttled or shut down in various hazardous situations, e.g. temperatures of more than 150° C. or pressures of more than 35 bar and in case of significant pressure drop due to leaks, for example. The control concept can be summarized in such a way that the state downstream of the evaporator is controlled via the state of the refrigerant downstream of the compressor.

The solution is expedient, in particular for indirect refrigerant systems.

### BRIEF DESCRIPTION OF DRAWINGS

Further details, features and advantages of embodiments of the invention result from the following description of examples of embodiment with reference to the corresponding drawings. The illustrations show the following:

FIG. 1: Partial cross-sectional view of the refrigerant compressor with pressure relief arrangement

FIG. 2: Cross-sectional view of the heat exchanger with pressure relief arrangement, and

FIG. 3: Log Ph diagram of the superheat.

### DESCRIPTION OF AN EMBODIMENT

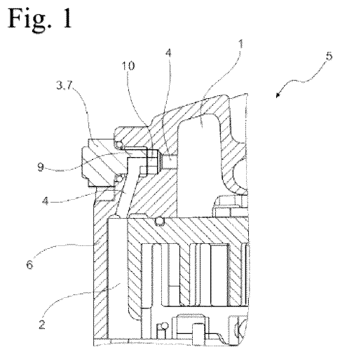

FIG. 1 shows a partial cross-sectional view of a refrigerant compressor with a pressure relief arrangement according to the invention. It was foregone to represent the complete refrigerant compressor, and only the part that comprises the pressure relief arrangement is shown. A compressor 5 according to the principle of spiral compressors is represented as the refrigerant compressor. Compressors of this type are also called scroll compressors or spiral compressors. According to its functionality, a compressor 5 exhibits a high-pressure side 1 of the refrigerant, and a low-pressure side 2. The task of a compressor 5 is to compress the refrigerant vapor to high pressure by using the low pressure from the low-pressure side 2 in accordance with the mechanical principle of operation and then to convey it from the compressor 5 into the refrigerant circuit on the high-pressure side 1. Thus, ultimately, the pressure relief arrangement consists of the combination of an overpressure relief device 3 that is produced in the represented example of embodiment as the pressure relief valve 7, and a pressure relief channel 4 within which the overpressure relief device 3 is arranged. The pressure relief channel 4 effectively establishes a short-circuit connection from the high-pressure side 1 to the low-pressure side 2 in case of overpressure and in case of triggering of the overpressure relief device 3. Then, to avoid problems and destruction with resulting escape of the refrigerant from the circuit, the refrigerant flows at high pressure in a controlled manner via the pressure relief channel 4 to the low-pressure side 2 after triggering of the pressure relief valve 7, and the high-pressure side 1 of the refrigerant circuit is protected from mechanical destruction due to overpressure thanks to the performed pressure equalization. In the embodiment shown here, the pressure relief valve is screwed into the housing 6 of the compressor 5 from the outside. To this end, the valve body 9 exhibits an external thread on the cylindrical perimeter, which is indicated in the figure and corresponds with an internal thread in the housing 6 of the compressor 5. The pressure relief valve 7 is screwed into the housing 6 from the outside and is sealed externally by way of a gasket that is not specified in detail here and produced as an 0-ring in the example of embodiment. The valve body 9 exhibits an axial through-hole that releases a flow path for the fluid from the pressure relief channel 4 via the valve body 9 of the pressure relief valve 7 towards the low-pressure side 2 in the compressor 5 in case of pressure relief. The flow path for the refrigerant inside the valve body 9 is also called overflow channel 10. When the pressure relief valve 7 is triggered, the flow path is switched from the high-pressure side 1 via the pressure relief channel 4 to the pressure relief valve 7 and through its valve body 9 in the overflow channel 10 to continue the pressure relief channel 4 towards the low-pressure side 2.

Alternatively, to the represented embodiment of embedding the pressure relief valve 7 in the design inside the compressor 5, the most varied designs and implementations of this safety principle can be realized. For example, to prevent risks arising from leaks, the overpressure relief device 3 can be integrated into the housing 6 of the compressor 5 from the inside so that no external sealing is required due to the externally closed housing 6.

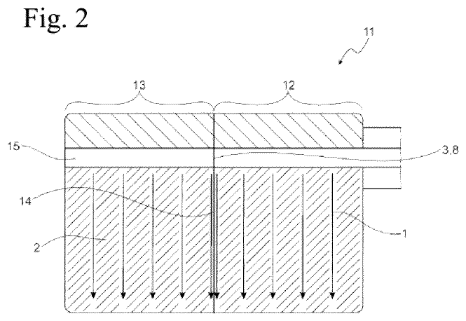

FIG. 2 shows a cross-sectional view of a heat exchanger with pressure relief arrangement, wherein the heat exchanger 11 comprises heat transfer modules that are produced as the condenser 12 and evaporator 13 inside an integrated heat exchanger 11. The condenser 12 is arranged on the high-pressure side 1 of the refrigerant circuit and is physically separated from the evaporator 13 by an adjacent separation wall 14 that is installed on the low-pressure side 2 of the refrigerant circuit. In the separation wall 14, an overpressure relief device 3 is produced as a so-called rupture disc 8 that at a specified overpressure releases a flow path in the separation wall 14 from the condenser 12 to the evaporator 13 so that refrigerant can escape with high pressure through the overpressure relief device 3 at a specified place and at a specified pressure and thus protect the heat exchanger 11 from destruction. According to the shown preferred embodiment, the overpressure relief device 3 is arranged in the separation wall 14 in the area of the manifold/collector 15, resulting in a very efficient and concentrated flow and thus a very fast pressure equalization between high-pressure side 1 and low-pressure side 2. Thanks to the positioning in the manifold/collector 15, a special contribution is made to risk mitigation.

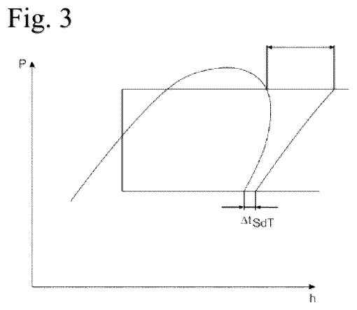

FIG. 3 shows a log Ph diagram of a refrigerant circuit as an example. In the case of low pressure, the superheat as the temperature difference AtSdT is as measured according to the state of the art for the superheat control at the evaporator outlet. In the case of high pressure, the superheat is represented as the temperature difference in the range between 15 and 25 K with AtE according to the invention. The superheat is preferably controlled in the range between 15 and 20 K A with tE according to the invention. The superheat control allows much more stable control at high pressure.

The invention relates to a pressure relief arrangement in refrigerant circuits, in particular in mobile refrigerant systems and heat pumps.

What is claimed is:

1. A pressure relief arrangement in a refrigerant circuit comprising:
a high-pressure side; and
a low-pressure side, wherein the high-pressure side is fluidically connected with the low-pressure side of the refrigerant circuit via an overpressure relief device, wherein the overpressure relief device provides for pressure reduction of overpressure in case of an overpressure on the high-pressure side, and fluid flows from the high-pressure side to the low-pressure side of the refrigerant circuit, wherein the overpressure relief device is a pressure relief valve and includes a valve body, and wherein an overflow channel runs axially in the valve body.

2. The pressure relief arrangement according to claim 1, wherein the pressure relief valve is a safety valve.

3. The pressure relief arrangement according to claim 1, wherein the overpressure relief device connects one component of the refrigerant circuit with high pressure with another component of the refrigerant circuit with low pressure.

4. The pressure relief arrangement according to claim 1, wherein the overpressure relief device is arranged in a pressure relief channel between the high-pressure side and the low-pressure side of the overpressure relief device.

5. The pressure relief arrangement according to claim 4, wherein the pressure relief channel is formed inside a housing of a compressor

6. The pressure relief arrangement according to claim 5, wherein the pressure relief valve is screwed into the housing.

7. The pressure relief arrangement according to claim 1, wherein the overpressure relief device is arranged in a manifold of a heat exchanger.
